(19) United States
(12) Patent Application Publication
(10) Pub. No.: US 2023/0056798 A1
(43) Pub. Date: Feb. 23, 2023

(54) DOCUMENT PROCESSING DEVICE AND DOCUMENT PROCESSING METHOD

(71) Applicant: TOSHIBA TEC KABUSHIKI KAISHA, Tokyo (JP)

(72) Inventor: Ryuichi Aoyama, Mishima Shizuoka (JP)

(21) Appl. No.: 17/889,427

(22) Filed: Aug. 17, 2022

(30) Foreign Application Priority Data
Aug. 23, 2021 (JP) 2021-135612

(51) Int. Cl. G06F 40/123; G06F 16/93; G06F 3/12

(52) U.S. Cl. CPC G06F 40/123; G06F 16/93; G06F 3/1201

(57) ABSTRACT

According to one embodiment, a document processing device includes a plurality of storage units, a specification unit, and a processing unit. The storage units are set with respectively different setting information. The storage unit stores a processing target document. The specification unit specifies a processing target area determined by the setting information set in the storage unit for each of the documents respectively stored in the plurality of storage units. The processing unit executes, for each document, a predetermined process on a content located in the processing target area specified by the specification unit.

### CROSS-REFERENCE TO RELATED APPLICATION

This application is based upon and claims the benefit of priority from Japanese Patent Application No. 2021-135612, filed on Aug. 23, 2021, the entire contents of which are incorporated herein by reference.

### FIELD

Embodiments described herein relate generally to a document processing device and a document processing method.

### BACKGROUND

In the related art, there is a document processing device that specifies an area marked from a document including a content formed of a text or an image, and executes a process corresponding to a marking type on the content located in the area. According to the above-described document processing device, for example, a first process can be executed on any content of the document by applying a type of marking, corresponding to the first process, to an area where a content to be subjected to the first process exists.

Meanwhile, there is a request to selectively use the document processing device between different cases including one case in which the first process is executed on a first content of one document, and the other case in which the first process is executed on a second content different from the first content. In order to execute the first process on a content, it is required to apply a type of marking, corresponding to the first process, to an area where the content exists. That is, the same marking is applied to a first area where the first content exists and to a second area where the second content exists. However, in the document processing device of the related art, the same processing is executed on the content of the area to which the same marking is applied. Therefore, the first process is executed on each of the first content and the second content, and as such, the document processing device cannot be selectively used between the different cases.

### DESCRIPTION OF THE DRAWINGS

FIG. 1 is a schematic configuration diagram of a document processing system;

FIG. 2 is a block diagram showing an internal circuit configuration of a processing server;

FIG. 3 is a sequence diagram of a data signal transmitted and received to and from the processing server, a terminal, and a printer that form the document processing system;

FIG. 4 is a flowchart showing an information processing procedure executed by a processor of the processing server according to a document processing program;

FIG. 5 is a flowchart showing the information processing procedure; and

FIG. 6 is a schematic diagram showing an example of a processing result with respect to a document.

### DETAILED DESCRIPTION

A problem to be solved by embodiments is to provide a document processing device that can be used in a variety of ways.

In general, according to one embodiment, a document processing device includes a plurality of storage units, a specification unit, and a processing unit. The storage units are set with respectively different setting information. The storage unit stores a processing target document. The specification unit specifies a processing target area determined by the setting information set in the storage unit for each of the documents respectively stored in the plurality of storage units. The processing unit executes, for each document, a predetermined process on a content located in the processing target area specified by the specification unit.

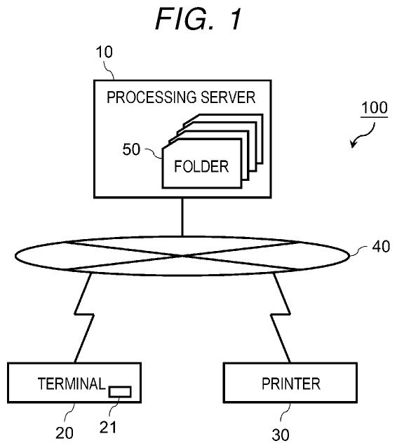

Hereinafter, an embodiment of a document processing device will be described with reference to the drawings. FIG. 1 is a schematic configuration diagram of a document processing system 100. The document processing system 100 includes a processing server 10, a terminal 20, and a printer 30. The processing server 10, the terminal 20, and the printer 30 are connected to each other by a communication network 40. The communication network 40 is a wide area network in which a public line or a dedicated line is used as a relay network, and a wired local area network (LAN), a wireless LAN, a mobile communication network, and a mobile phone communication network are used as access networks. The communication network 40 may be a narrow area network based on the wired LAN or the wireless LAN.

The terminal 20 functions as a document generation device for generating a document. The document is electronic data including one or a plurality of contents formed of a text or an image. A user can generate a desired document by operating the terminal 20.

The terminal 20 also functions as a document storage device for storing the document. The terminal 20 includes a storage medium 21 and can store the generated document and the document processed by the processing server 10 in the storage medium 21. For example, a flash memory, a USB memory, an SD memory card, a solid state drive (SSD), a hard disc drive (HDD), and the like are used as the storage medium. The terminal 20 corresponds to a terminal having a communication function such as a personal computer, a tablet type terminal, and a smartphone.

The printer 30 functions as a document printing device that prints out a document. The printer 30 is a network printer that performs a printing operation according to a print job given via the communication network 40. For example, a laser printer, an inkjet printer, a multifunction printer, and the like correspond to the printer 30.

The processing server 10 uses cloud computing and receives a document generated by the terminal 20 via the communication network 40. Next, the processing server 10 executes a predetermined process on the document, and outputs the processed document to the terminal 20 or the printer 30. That is, the processing server 10 functions as a document processing device. The processing server 10 includes a plurality of folders 50. Each folder 50 functions as a storage unit for storing each processing target document.

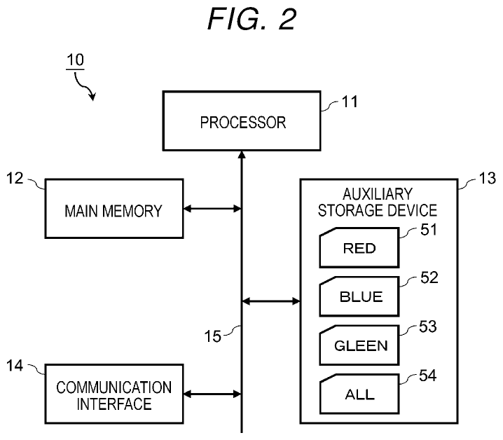

FIG. 2 is a block diagram showing an internal circuit configuration of the processing server 10. The processing server 10 includes a processor 11, a main memory 12, an auxiliary storage device 13, and a communication interface 14. The processing server 10 forms a computer by connecting the processor 11 to the main memory 12, the auxiliary storage device 13, and the communication interface 14 with a system transmission line 15.

The processor 11 corresponds to a central portion of the computer. The processor 11 controls each unit to implement various functions as the processing server 10 according to an operating system or an application program. The processor 11 is, for example, a central processing unit (CPU).

The main memory 12 corresponds to a main storage portion of the computer. The main memory 12 includes a non-volatile memory area and a volatile memory area. The main memory 12 stores the operating system or the application program in the non-volatile memory area. The main memory 12 may store data necessary for the processor 11 to execute a process for controlling each unit in the non-volatile or volatile memory area. The main memory 12 uses the volatile memory area as a work area where the processor 11 appropriately rewrites data. The non-volatile memory area is, for example, a read only memory (ROM). The volatile memory area is, for example, a random access memory (RAM).

The auxiliary storage device 13 corresponds to an auxiliary storage portion of the computer. For example, an electric erasable programmable read-only memory (EEPROM), an HDD, an SSD, and the like can be used as the auxiliary storage device 13. The auxiliary storage device 13 stores data used by the processor 11 for performing various processes, and data generated by the process of the processor 11. The auxiliary storage device 13 may store the application program.

The communication interface 14 is connected to the communication network 40. The processing server 10 performs data communication with the terminal 20 and the printer 30 connected to the communication network 40 via the communication interface 14 according to a predetermined communication protocol.

In FIG. 1, the number of terminals 20 and the number of printers 30 are respectively one, and the number of respective terminals 20 and printers 30 is not limited to one. Two or more terminals 20 or printers 30 may be connected to the communication network 40. It goes without saying that a device other than the terminal 20 and the printer 30 may be connected to the communication network 40.

The processing server 10 having the above-described configuration uses a part of the storage area in the auxiliary storage device 13 as an area of a plurality of folders 50. The embodiment describes four types of folders 50 including a RED folder 51, a BLUE folder 52, a GREEN folder 53, and an ALL folder 54. The RED folder 51 is a document folder whose folder name is “RED”. The BLUE folder 52 is a document folder whose folder name is “BLUE”. The GREEN folder 53 is a document folder whose folder name is “GREEN”. The ALL folder 54 is a document folder whose folder name is “ALL”.

One of the application programs stored in the main memory 12 or the auxiliary storage device 13 is a document processing program. The document processing program is used for allowing the computer of the processing server 10 to execute the following processes Sa, Sb, Sc, and Sd.

The Process Sa: a first process is executed on a content in an area surrounded by a red frame of a document stored in the RED folder 51.

The process Sb: the first process is executed on a content in an area surrounded by a blue frame of a document stored in the BLUE folder 52.

The process Sc: the first process is executed on a content in an area surrounded by a green frame of a document stored in the GREEN folder 53.

The process Sd: the first process is executed on a content in each area surrounded by the red, blue, and green frames of a document stored in the ALL folder 54.

In the embodiment, the first process is defined as an encoding process in which a text (a character string) forming the content is converted into a two-dimensional code (a QR code (registered trademark)).

A method of installing the document processing program in the main memory 12 or the auxiliary storage device 13 is not particularly limited. The document processing program can be installed in the main memory 12 or the auxiliary storage device 13 by recording a control program in a removable recording medium or distributing the control program by communication via a network. The recording medium may be any medium such as a CD-ROM and a memory card as long as the recording medium can store a program non-temporarily and can be read by a device, and a form thereof is not limited thereto.

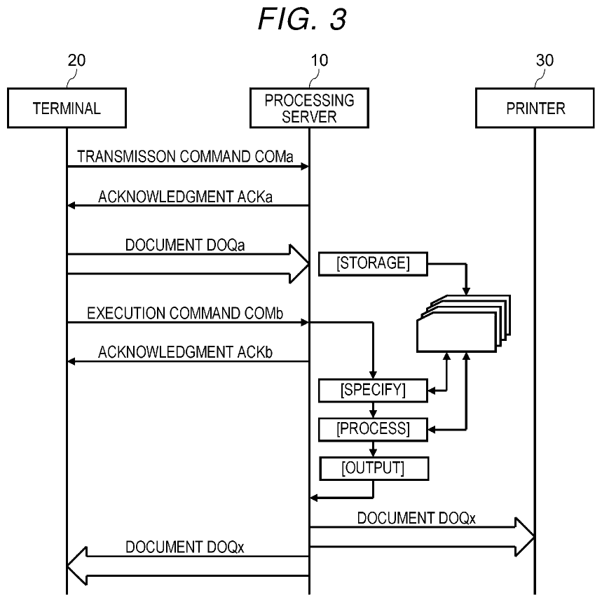

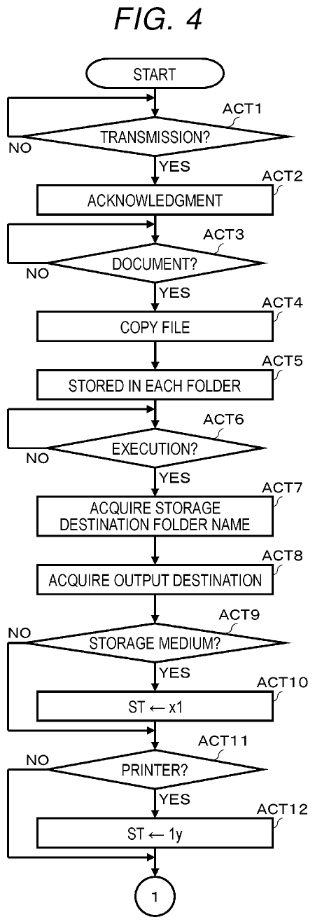

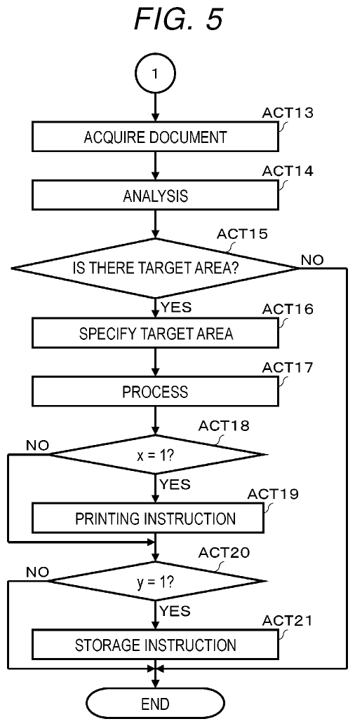

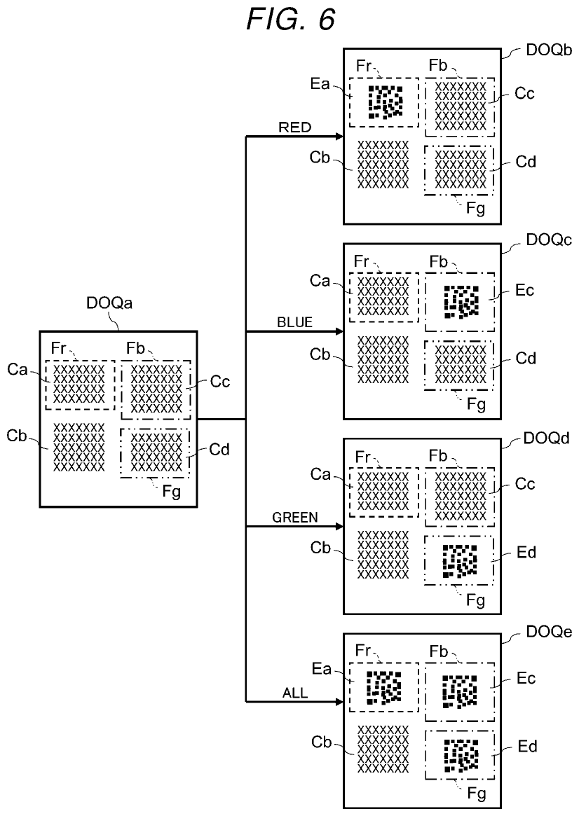

FIG. 3 is a sequence diagram of a data signal transmitted and received to and from the processing server 10, the terminal 20, and the printer 30 that form the document processing system 100. FIGS. 4 and 5 are flowcharts showing an information processing procedure executed by the processor 11 of the processing server 10 according to the document processing program. FIG. 6 is a schematic diagram showing an example of a processing result with respect to a document. Hereinafter, a main operation of the document processing system 100 will be described with reference to FIGS. 3 to 6. The operation shown below is an example. For example, the information processing procedure is not limited to the information processing procedure shown in the drawings as long as the same effect can be obtained.

First, a user operates the terminal 20 to generate a document DOQa which is a processing target (refer to FIG. 6). The document DOQa includes four contents of Ca, Cb, Cc, and Cd formed of a text (a character string).

Next, the user surrounds a content, on which an encoding process is desired to be performed by the processing server 10, with a predetermined color frame. For example, the user surrounds the content Ca with a red frame (a broken line) Fr, the content Cc with a blue frame (an alternate long and short dash line) Fb, and the content Cd with a green frame (an alternate long and two short dashes line) Fg. The content Cb is not surrounded by a frame.

The color of the frame is a color used as the folder name of each folder 50 provided in the processing server 10. That is, there are three types of colors including a red color corresponding to the folder name “RED” of the RED folder 51, a blue color corresponding to the folder name “BLUE” of the BLUE folder 52, and a green color corresponding to the folder name “GREEN” of the GREEN folder 53. The folder name “ALL” of the ALL folder 54 corresponds to all the colors of red, blue, and green.

A line type of the frame is not limited. For example, the content may be surrounded by a solid line. All the contents may be surrounded by frames having the same line type. The inside of the frame may be marked with the same color as that of the frame. For example, the content Ca may be marked in red, the content Cc may be marked in blue, and the content Cd may be marked in green. In short, a processing target content can be identified by the color corresponding to the folder name of each folder 50.

The user who completed generating the document DOQa performs, to the terminal 20, an operation for transmitting the document DOQa to the processing server 10. By this operation, a transmission command COMa (refer to FIG. 3) is output from the terminal 20. The transmission command COMa is transmitted to the processing server 10 via the communication network 40.

As shown in FIG. 4, the processor 11 of the processing server 10 waits for the transmission command COMa in ACT 1. When receiving the transmission command COMa via the communication interface 14, the processor 11 determines YES in ACT 1 and proceeds to ACT 2. The processor 11 returns an acknowledgment command ACKa (refer to FIG. 3) in ACT 2. The acknowledgment command ACKa is output from the communication interface 14 and then transmitted to the terminal 20, which is a transmission source of the transmission command COMa, via the communication network 40.

The terminal 20 receiving the acknowledgment command ACKa transmits a document file storing the document DOQa to the processing server 10. The document file is transmitted to the processing server 10 via the communication network 40.

The processor 11 transmitting the acknowledgment command ACKa waits for the document file in ACT 3. When receiving the document file via the communication interface 14, the processor 11 determines YES in ACT 3 and proceeds to ACT 4. The processor 11 copies the number of document files corresponding to the number of folders 50, that is, four document files in ACT 4. Next, the processor 11 respectively stores the four document files copied in ACT 5 in the RED folder 51, the BLUE folder 52, the GREEN folder 53, and the ALL folder 54.

The user performs an operation for instructing the processing server 10 to execute a process on the document DOQa. At this time, the user designates a color corresponding to the folder name of the folder 50 in which the processing target document is stored. For example, since a list of colors corresponding to the folder names of the respective folders 50 is displayed on a display of the terminal 20, the user selects and designates a desired color from the list thereof. The user also designates an output destination of a processed document DOQx (refer to FIG. 3). In the embodiment, the user designates the printer 30 or the storage medium 21 of the terminal 20 as the output destination thereof. Alternatively, the user may designate both the printer 30 and the storage medium 21.

If the user designates the color and the output destination, an execution command COMb (refer to FIG. 3) is output from the terminal 20. The execution command COMb is transmitted to the processing server 10 via the communication network 40. The execution command COMb includes two pieces of information on the color corresponding to the folder name of a storage destination folder and the output destination, which are designated by the user. The execution command COMb also includes a file name of the document file that stores the processing target document.

The processor 11 of the processing server 10 waits for the execution command COMb in ACT 6. When receiving the execution command COMb via the communication interface 14, the processor 11 determines YES in ACT 6 and proceeds to ACT 7. The processor 11 acquires the information on the color corresponding to the folder name of the storage destination folder from the execution command COMb in ACT 7.

The processor 11 acquires the information on the output destination from the execution command COMb in ACT 8. The processor 11 confirms whether or not the storage medium 21 is designated as the output destination in ACT 9. If the storage medium 21 is not designated as the output destination, the processor 11 determines NO in ACT 9, skips a process of ACT 10, and proceeds to ACT 11. On the other hand, if the storage medium 21 is designated as the output destination, the processor 11 determines YES in ACT 9 and proceeds to ACT 10. The processor 11 sets a ones place y of a status formed of a double-digit numerical value indicating the output destination to “1” in ACT 10. After that, the processor 11 proceeds to ACT 11.

The processor 11 confirms whether or not the printer 30 is designated as the output destination in ACT 11. If the printer 30 is not designated as the output destination, the processor 11 determines NO in ACT 11, skips a process of ACT 12, and proceeds to ACT 13 of FIG. 5. On the other hand, if the printer 30 is designated as the output destination, the processor 11 determines YES in ACT 11 and proceeds to ACT 12. The processor 11 sets a tens place x of the status formed of the double-digit numerical value indicating the output destination to “1” in ACT 12. After that, the processor 11 proceeds to ACT 13.

The processor 11 acquires the document file of the file name included in the execution command COMb from the folder 50 of the folder name corresponding to the information on the color acquired from the execution command COMb in ACT 13. The processor 11 analyzes the document DOQa stored in the document file in ACT 14. Next, the processor 11 confirms presence or absence of a processing target area, that is, a content area surrounded by the color corresponding to the folder name in ACT 15.

For example, in the case of the document DOQa of the document file acquired from the RED folder 51 whose folder name is “RED”, the processor 11 confirms presence or absence of a content area surrounded by the red frame Fr. In the case of the document DOQa of the document file acquired from the BLUE folder 52 whose folder name is “BLUE”, the processor 11 confirms presence or absence of a content area surrounded by the blue frame Fb. In the case of the document DOQa of the document file acquired from the GREEN folder 53 whose folder name is “GREEN”, the processor 11 confirms presence or absence of a content area surrounded by the green frame Fg. In the case of the document DOQa of the document file acquired from the ALL folder 54 whose folder name is “ALL”, the processor 11 confirms presence or absence of content areas surrounded by the red frame Fr, the blue frame Fb, and the green frame Fg.

If the content area to be processed does not exist, the processor 11 determines NO in ACT 15. The processor 11 ends the process for the execution command COMb.

If the content area to be processed exists, the processor 11 determines YES in ACT 15 and proceeds to ACT 16. The processor 11 specifies the processing target area from the document DOQa in ACT 16. For example, if the document DOQa of the document file acquired from the RED folder 51 whose folder name is “RED” includes the content area surrounded by the red frame Fr, the processor 11 specifies the content area as the processing target area. For example, if the document DOQa of the document file acquired from the BLUE folder 52 whose folder name is “BLUE” includes the content area surrounded by the blue frame Fb, the processor 11 specifies the content area as the processing target area. For example, if the document DOQa of the document file acquired from the GREEN folder 53 whose folder name is “GREEN” includes the content area surrounded by the green frame Fg, the processor 11 specifies the content area as the processing target area. For example, if the document DOQa of the document file acquired from the ALL folder 54 whose folder name is “ALL” includes the content areas respectively surrounded by the red frame Fr, the blue frame Fb, and the green frame Fg, the processor 11 specifies each area as the processing target area.

The processor 11 executes an encoding process, in which the text (the character string) is converted into a two-dimensional code, on the content in the area specified as a processing target in ACT 17. For example, if the area specified as the processing target is the area surrounded by the red frame Fr, the processor 11 executes the encoding process in which the content Ca is converted into a two-dimensional code Ea (refer to FIG. 6). If the area specified as the processing target is the area surrounded by the blue frame Fb, the processor 11 executes the encoding process in which the content Cc is converted into a two-dimensional code Ec (refer to FIG. 6). If the area specified as the processing target is the area surrounded by the green frame Fg, the processor 11 executes the encoding process in which the content Cd is converted into a two-dimensional code Ed (refer to FIG. 6).

After completing the encoding process, the processor 11 confirms whether or not the tens place x of the status indicating the output destination is “1” in ACT 18. If the tens place x is not “1”, the processor 11 determines NO in ACT 18, skips a process of ACT 19, and proceeds to ACT 20.

On the other hand, if the tens place x is “1”, the processor 11 determines YES in ACT 18 and proceeds to ACT 19. The processor 11 outputs a printing instruction of the document DOQx, the encoding process of which is completed, to the printer 30 in ACT 19. The printing instruction is transmitted from the processing server 10 to the printer 30 via the communication network 40. As a result, the document DOQx is printed out from the printer 30. For example, the document DOQa stored in the RED folder 51 whose folder name is “RED” is printed out as a document DOQb (refer to FIG. 6) in which the content Ca in the red frame Fr is converted into the two-dimensional code Ea. The document DOQa stored in the BLUE folder 52 whose folder name is “BLUE” is printed out as a document DOQc (refer to FIG. 6) in which the content Cc in the blue frame Fb is converted into the two-dimensional code Ec. The document DOQa stored in the GREEN folder 53 whose folder name is “GREEN” is printed out as a document DOQd (refer to FIG. 6) in which the content Cd in the green frame Fg is converted into the two-dimensional code Ed. The document DOQa stored in the ALL folder 54 whose folder name is “ALL” is printed out as a document DOQe (refer to FIG. 6) in which the content Ca in the red frame Fr is converted into the two-dimensional code Ea, the content Cc in the blue frame Fb is converted into the two-dimensional code Ec, and the content Cd in the green frame Fg is converted into the two-dimensional code Ed.

The processor 11 outputting the printing instruction proceeds to ACT 20. The processor 11 confirms whether or not the ones place y of the status indicating the output destination is “1” in ACT 20. If the ones place y is not “1”, the processor 11 determines NO in ACT 20. The processor 11 ends the process for the execution command COMb.

If the ones place y is “1”, the processor 11 determines YES in ACT 20 and proceeds to ACT 21. The processor 11 outputs a storage instruction of the document DOQx, the encoding process of which is completed, to the terminal 20 in ACT 21. The storage instruction is transmitted from the processing server 10 to the terminal 20, which is the execution command transmission source, via the communication network 40. As a result, the terminal 20 stores the document DOQx in the storage medium 21. For example, the document DOQa stored in the RED folder 51 whose folder name is “RED” is stored in the storage medium 21 as the document DOQb (refer to FIG. 6) in which the content Ca in the red frame Fr is converted into the two-dimensional code Ea. The document DOQa stored in the BLUE folder 52 whose folder name is “BLUE” is stored in the storage medium 21 as the document DOQc (refer to FIG. 6) in which the content Cc in the blue frame Fb is converted into the two-dimensional code Ec. The document DOQa stored in the GREEN folder 53 whose folder name is “GREEN” is stored in the storage medium 21 as the document DOQd (refer to FIG. 6) in which the content Cd in the green frame Fg is converted into the two-dimensional code Ed. The document DOQa stored in the ALL folder 54 whose folder name is “ALL” is stored in the storage medium 21 as the document DOQe (refer to FIG. 6) in which the content Ca in the red frame Fr is converted into the two-dimensional code Ea, the content Cc in the blue frame Fb is converted into the two-dimensional code Ec, and the content Cd in the green frame Fg is converted into the two-dimensional code Ed.

The processor 11 outputting the storage instruction ends the process for the execution command COMb. The processor 11 may first execute the processes of ACT 20 and ACT 21, that is, the process of outputting the storage instruction, and then may execute the processes of ACT 18 and ACT 19, that is, the process of outputting the printing instruction. The processor 11 may simultaneously perform the process of outputting the printing instruction and the process of outputting the storage instruction in parallel.

Here, the processor 11 implements a function as a specification unit by the processes of ACT 13 to ACT 16. The processor 11 implements a function as a processing unit by the process of ACT 17. The processor 11 implements a function as an output unit by the processes of ACT 18 to ACT 21.

As described in detail above, according to the embodiment, it is possible to easily and selectively use a case where the encoding process is executed on a first content on one document DOQa, for example, the content Ca, and a case where the encoding process is executed on a second content, for example, the content Cc.

That is, when executing the encoding process on the content Ca, the user may designate the RED folder 51 whose folder name is “RED” and instruct the processing server 10 to execute the encoding process. By this instruction, in the processing server 10, the content Ca of the document DOQa is converted into the two-dimensional code Ea, and as such, the document DOQb is generated.

When executing the encoding process on the content Cc, the user may designate the BLUE folder 52 whose folder name is “BLUE” and instruct the processing server 10 to execute the encoding process. By this instruction, in the processing server 10, the content Cc of the document DOQa is converted into the two-dimensional code Ec, and as such, the document DOQc is generated.

In the same manner, the user designates the GREEN folder 53 whose folder name is “GREEN” and instructs the processing server 10 to execute the encoding process. By this instruction, in the processing server 10, the content Cd of the document DOQa is converted into the two-dimensional code Ed, and as such, the document DOQd is generated.

The user also designates the ALL folder 54 whose folder name is “ALL” and instructs the processing server 10 to execute the encoding process. By this instruction, in the processing server 10, the content Ca, the content Cc, and the content Cd of the document DOQa are respectively converted into the two-dimensional codes Ea, Ec, and Ed, and as such, the document DOQe is generated.

As described above, according to the embodiment, variety of documents DOQb, DOQc, DOQd, and DOQe can be easily generated from one document DOQa.

In the embodiment, the output destinations of the processed documents DOQb, DOQc, DOQd, and DOQe can be designated as either one or both of printing and storage. For example, if the user designates the printing, the documents DOQb, DOQc, DOQd, and DOQe are printed out from the printer 30. If the user designates the storage, the documents DOQb, DOQc, DOQd, and DOQe are stored in the storage medium 21 of the terminal 20. Therefore, it is possible to easily take measures in a variety of ways with respect to the output destination of the processed document.

While the embodiment of the document processing device is described above, the embodiment is not limited thereto.

The embodiment describes a case in which the information on the color for specifying the processing target area is acquired from the folder name of the folder 50. Regarding this point, for example, the information on the color may be acquired from setting information on an attribute given to a directory of the folder 50. That is, “RED” is set as the setting information on the attribute with respect to the RED folder 51, “BLUE” is set as the setting information on the attribute with respect to the BLUE folder 52, “GREEN” is set as the setting information on the attribute with respect to the GREEN folder 53, and “ALL” is set as the setting information on the attribute with respect to the ALL folder 54. In this manner as well, the same effect as that of the embodiment can be obtained.

For example, “RED” and “GREEN” are set as the setting information on the attribute in the folder. Accordingly, in the document DOQa stored in this folder, the content Ca in the area surrounded by the red frame Fr and the content Cd in the area surrounded by the green frame Fg are respectively converted into the two-dimensional codes Ea and Ec by the processing server 10. Such use can also be easily performed depending on the setting information on the attribute of the folder 50.

Instead of identifying the processing target area by color, the processing target area may be identified by another information such as a line type of a frame surrounding the area. For example, the processing server 10 includes a first folder in which information called a solid line frame is set as setting information on an attribute, and a second folder in which information called a broken line frame is set as the setting information on the attribute. Accordingly, the processing server 10 executes the first process on a content in an area surrounded by the solid line frame, with respect to a document in the first folder. The processing server 10 executes the first process on a content in an area surrounded by the broken line frame, with respect to a document in the second folder. In this configuration as well, the same effect as that of the embodiment can be obtained.

The first process executed by the processing server 10 is not limited to the encoding process in which a text is converted into a two-dimensional code. The first process may be a decoding process in which a two-dimensional code or a barcode is converted into a text. The processing target content is not limited to the text. For example, a content of an image is used as the processing target content. It is also possible to execute, as the first process, a so-called trimming process of cutting out an area in which this image is recorded.

In the embodiment, the printer 30 and the storage medium 21 are described as the output destination of the processed document. The output destination is not limited thereto. For example, the processed document may be displayed and output on a screen of a monitor device connected to the communication network 40. The processed document may be stored in a storage medium of another terminal instead of being stored in the terminal 20 which is the execution command transmission source.

The terminal 20 or the printer 30 may execute all or at least a part of the processes described as being executed by the processing server 10 in the embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A document processing device, comprising:
a plurality of storage units configured to be set with respectively different setting information, and to store a respective processing target document;
a specification unit configured to specify a processing target area determined by the setting information set in each storage unit associated with each of the processing target documents respectively stored in the plurality of storage units; and
a processor configured to execute, for each processing target document, a predetermined process on a content located in the processing target area specified by the specification unit.

2. The document processing device according to claim 1, wherein:
the processing target document includes a plurality of contents in which different areas become processing targets by the setting information set in the different storage units, and
the processor executes a same process on the content located in the processing target area specified by the specification unit.

3. The document processing device according to claim 1, further comprising:
an output unit configured to output the processing target document on which the predetermined process is executed by the processor.

4. The document processing device according to claim 3, wherein
the output unit outputs the processing target document to a printer according to a printing instruction.

5. The document processing device according to claim 3, wherein
the output unit outputs the processing target document to a storage medium according to a storage instruction.

6. The document processing device according to claim 1, wherein:
each of the plurality of storage units is constituted by a folder in a memory.

7. The document processing device according to claim 1, wherein:
the specification unit is further configured to specify a plurality of processing target areas that do not overlap with each other.

8. A document processing method of causing a computer including a plurality of storage units configured to be set with respectively different setting information and to store a respective processing target document to perform functions including:
specifying a processing target area determined by the setting information set in each storage unit associated with each of the processing target documents respectively stored in the plurality of storage units; and
executing, for each processing target document, a predetermined process on a content located in the processing target area specified.

9. The document processing method according to claim 8, wherein:
the processing target document includes a plurality of contents in which different areas become processing targets by the setting information set in the different storage units, and further comprising:
executing a same process on the content located in the processing target area specified.

10. The document processing method according to claim 8, further comprising:
outputting the processing target document on which the predetermined process is executed.

11. The document processing method according to claim 10, further comprising:
outputting the processing target document to a printer according to a printing instruction.

12. The document processing method according to claim 10, further comprising:
outputting the processing target document to a storage medium according to a storage instruction.

13. The document processing method according to claim 8, wherein:
each of the plurality of storage units is constituted by a folder in a memory.

14. The document processing method according to claim 8, further comprising:
specifying a plurality of processing target areas that do not overlap with each other.

15. A non-transitory computer readable medium causing a computer to execute a document processing method of causing the computer including a plurality of storage units configured to be set with respectively different setting information and to store a respective processing target document to perform functions including:
specifying a processing target area determined by the setting information set in each storage unit associated with each of the processing target documents respectively stored in the plurality of storage units; and
executing, for each processing target document, a predetermined process on a content located in the processing target area specified.

16. The non-transitory computer readable medium according to claim 15, wherein:
the processing target document includes a plurality of contents in which different areas become processing targets by the setting information set in the different storage units, and further comprising:
executing a same process on the content located in the processing target area specified.

17. The non-transitory computer readable medium according to claim 15, further comprising:
outputting the processing target document on which the predetermined process is executed.

18. The non-transitory computer readable medium according to claim 17, further comprising:
outputting the processing target document to a printer according to a printing instruction.

19. The non-transitory computer readable medium according to claim 17, further comprising:
outputting the processing target document to a storage medium according to a storage instruction.

20. The non-transitory computer readable medium according to claim 15, further comprising:
specifying a plurality of processing target areas that do not overlap with each other.
